(19) United States
(12) Patent Application Publication
(10) Pub. No.: US 2012/0330576 A1
(43) Pub. Date: Dec. 27, 2012

(54) FUEL-INJECTION-CONDITION ESTIMATING APPARATUS

(75) Inventor: Naoki MIKAMI, Chiryu-city (JP)

(73) Assignee: DENSO CORPORATION, Kariya-city (JP)

(21) Appl. No.: 13/530,430

(22) Filed: Jun. 22, 2012

(30) Foreign Application Priority Data
Jun. 24, 2011 (JP) 2011-141132

(51) Int. Cl. G01M 15/09; G06F 19/00

(52) U.S. Cl. 702/50

(57) ABSTRACT

A fuel-injection-condition estimating apparatus is applied to a fuel injection system which includes a fuel injector injecting a fuel accumulated in an accumulator and a fuel pressure sensor detecting a fuel pressure in a fuel supply passage from the accumulator to an injection port of the fuel injector. The fuel-injection-condition estimating apparatus includes: a fuel-pressure-waveform detecting portion which detects a variation in the fuel pressure as a fuel pressure waveform based on a detection value of the fuel pressure sensor; and an injection-rate waveform computing portion which computes an injection-rate waveform indicative of a variation in an injection-rate based on the fuel pressure waveform. The injection-rate waveform computing portion computes an ascending-waveform portion where the injection-rate is ascending due to a fuel injection in such a manner that an injection-rate ascending speed becomes slower at a specified point on the ascending-waveform portion.

### CROSS-REFERENCE TO RELATED APPLICATION

This application is based on Japanese Patent Application No. 2011-141132 filed on Jun. 24, 2011, the disclosure of which is incorporated herein by reference.

### TECHNICAL FIELD

The present disclosure relates to a fuel-injection-condition estimating apparatus which computes an injection-rate waveform indicative of a variation in injection-rate of fuel.

### BACKGROUND

JP-2010-223182A (US-2010-0250096A1), JP-2010-223183A (US-2010-0250102A1), JP-2010-223184A (US-2010-0250097A1) and JP-2010-223185A (US-2010-0250095A1) respectively show a fuel injection system which is provided with a fuel pressure sensor detecting a fuel pressure in a fuel passage between a common-rail and an injection port of a fuel injector. Based on a detection value of the fuel pressure sensor, a fuel pressure waveform indicative of a variation in fuel pressure due to a fuel injection is detected. According to this system, since the injection-rate waveform indicative of the injection-rate can be computed based on the detected fuel pressure waveform, a fuel injection quantity can be estimated from an area of the injection-rate waveform (shaded area in FIG. 2B) and a fuel-injection-start time can be estimated from an ascending start point of the injection-rate. That is, the fuel injection condition can be estimated based on the injection-rate waveform.

Also, in the above system, the injection-rate waveform is trapezoid. That is, an injection-rate-ascend start time R1, an injection-rate-ascend end time R2, an injection-rate-descend start time R3 and an injection-rate-descend end time R4 are connected to each other, so than a trapezoid injection-rate waveform is formed.

### SUMMARY

Depending on a fuel injector, the actual injection-rate waveform is close to pentagon rather than trapezoid. FIG. 3 shows an injection-rate waveform of which shape is close to pentagon. Reference numerals (1) to (7) are measuring results of cases in which the fuel injection quantity is 2 mm³, 25 mm³, 50 mm³, 75 mm³, 100 mm³, 125 mm³, and 150 mm³, respectively.

According to this measuring result shown in FIG. 3, an injection-rate ascend speed becomes slower from a vicinity of a point denoted by “BP”. That is, as schematically shown in FIG. 4, the injection-rate ascending speed becomes slower from a bending point “Rx” before the injection rate reaches the injection-rate-ascend end point R2. The measured injection-rate waveform is close to pentagon connecting R1, Rx, Ry, R3, and R4 rather than trapezoid connecting R1, R2, R3 and R4.

Therefore, in a system where the injection-rate waveform is modeled into trapezoid, the injection-rate waveform is not computed with high accuracy. When estimating the injection condition based on the injection-rate waveform, the estimating accuracy can not be improved enough. Especially, when estimating the fuel injection quantity from the area of the injection-rate waveform, it is hard to estimate the fuel injection quantity with high accuracy.

Generally, a fuel injector includes a needle valve opening/closing an injection port, a backpressure chamber for generating back pressure applied to the needle valve, a control valve opening/closing an outlet of the backpressure chamber, and an orifice restricting fuel quantity flowing out from the backpressure chamber. When starting a fuel injection, the control valve is opened to decrease the backpressure, so that the needle valve opens the injection port.

However, some fuel injectors have a specific characteristic in which an opening area of the orifice becomes seemingly small before the fuel injection reaches the maximal injection-rate. In this case, since a descending speed of the backpressure becomes smaller, an opening speed of the needle valve also becomes slower. As the result, the ascending speed of the injection-rate becomes smaller before the fuel injection reaches the maximal injection-rate.

In view of the above, it is an object of the present disclosure to provide a fuel-injection-condition estimating apparatus in which a computing accuracy of an injection-rate waveform is improved.

According to the present disclosure, a fuel-injection-condition estimating apparatus is applied to a fuel injection system which includes a fuel injector injecting a fuel accumulated in an accumulator and a fuel pressure sensor detecting a fuel pressure in a fuel supply passage from the accumulator to an injection port of the fuel injector.

The fuel-injection-condition estimating apparatus includes: a fuel-pressure-waveform detecting portion which detects a variation in the fuel pressure as a fuel pressure waveform based on a detection value of the fuel pressure sensor; and an injection-rate waveform computing portion which computes an injection-rate waveform indicative of a variation in an injection-rate (fuel injection quantity per a unit time) based on the fuel pressure waveform.

The injection-rate waveform computing portion computes an ascending-waveform portion where the injection-rate is ascending due to a fuel injection in such a manner that an injection-rate ascending speed becomes slower at a specified point on the ascending-waveform portion.

According to the above, the injection-rate waveform which is close to an actual injection-rate waveform can be computed. Therefore, a fuel injection condition, such as a fuel injection quantity, can be accurately computed based on the computed injection-rate waveform.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a construction diagram showing an outline of a fuel injection system on which a fuel-injection-condition estimating apparatus is mounted, according to a first embodiment;

FIGS. 2A, 2B, and 2C are graphs showing variations in a fuel injection-rate and a fuel pressure relative to a fuel injection command signal;

FIG. 3 is a graph showing an experiment result obtained by the present inventor;

FIG. 4 is a chart schematically showing a pentagonal injection-rate waveform according to the first embodiment;

FIG. 5 is a block diagram showing a setting process of a fuel injection command signal according to the first embodiment;

FIGS. 6A, 6B and 6C are charts which respectively show an injection-cylinder pressure waveform Wa, a non-injection-cylinder pressure waveform Wu, and an injection pressure waveform Wb;

FIG. 7 is a flowchart showing a processing for computing a pentagonal injection-rate waveform according to the first embodiment; and

FIG. 8 is a chart schematically showing a hexagonal injection-rate waveform according to a second embodiment.

### DETAILED DESCRIPTION

Hereinafter, embodiments of the present invention will be described with reference to the drawings. A fuel-injection-condition estimating apparatus is applied to an internal combustion engine (diesel engine) having four cylinders #1-#4.

### First Embodiment

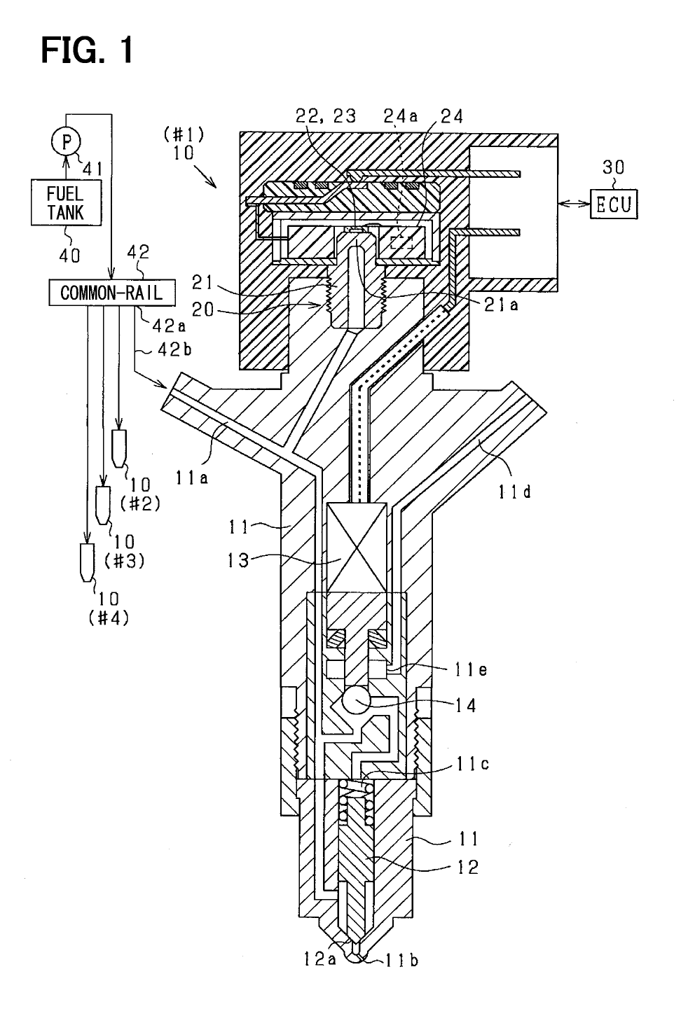

FIG. 1 is a schematic view showing fuel injectors 10 provided to each cylinder, a fuel pressure sensor 22 provided to each fuel injector 10, an electronic control unit (ECU) 30 and the like.

First, a fuel injection system of the engine including the fuel injector 10 will be explained. A fuel in a fuel tank 40 is pumped up by a high-pressure pump 41 and is accumulated in a common-rail (accumulator) 42 to be supplied to each fuel injector 10 (#1-#4). Each of the fuel injectors 10 (#1-#4) performs a fuel injection sequentially in a predetermined order.

The high-pressure fuel pump 41 is a plunger pump which intermittently discharges high-pressure fuel. Since the fuel pump 41 is driven by the engine through the crankshaft, the fuel pump 41 discharges the fuel predetermined times during one combustion cycle. The fuel injector 10 is comprised of a body 11, a needle valve body 12, an actuator 13 and the like. The body 11 defines a high-pressure passage 11a and an injection port 11b. The needle valve body 12 is accommodated in the body 11 to open/close the injection port 11b.

The body 11 defines a backpressure chamber 11c with which the high-pressure passage 11a and a low-pressure passage 11d communicate. A control valve 14 switches between the high-pressure passage 11a and the low-pressure passage 11d, so that the high-pressure passage 11a communicates with the backpressure chamber 11c or the low-pressure passage 11d communicates with the backpressure chamber 11c. When the actuator 13 is energized and the control valve 14 moves downward in FIG. 1, the backpressure chamber 11c communicates with the low-pressure passage 11d, so that the fuel pressure in the backpressure chamber 11c is decreased. Consequently, the back pressure applied to the valve body 12 is decreased so that the valve body 12 is lifted up (valve-open). A top surface 12a of the valve body 12 is unseated from a seat surface of the body 11, whereby the fuel is injected through the injection port 11b.

Meanwhile, when the actuator 13 is deenergized and the control valve 14 moves upward, the backpressure chamber 11c communicates with the high-pressure passage 11a, so that the fuel pressure in the backpressure chamber 11c is increased. Consequently, the back pressure applied to the valve body 12 is increased so that the valve body 12 is lifted down (valve-close). The top surface 12a of the valve body 12 is seated on the seat surface of the body 11, whereby the fuel injection is terminated.

The ECU 30 controls the actuator 13 to drive the valve body 12. When the needle valve body 12 opens the injection port 11b, high-pressure fuel in the high-pressure passage 11a is injected to a combustion chamber (not shown) of the engine through the injection port 11b. In addition, an orifice 11e is formed at an outlet of the backpressure chamber 11c. When the high-pressure fuel in the backpressure chamber 11c flows out into the low-pressure passage 11d, the orifice 11e restricts the fuel quantity under a specified quantity. It should be noted that the fuel injector 10 has a characteristic in which the opening area of the orifice 11e seemingly becomes smaller before the injection-rate reaches the maximal injection-rate after the control valve 14 is opened.

A fuel pressure sensor unit 22 includes a stem (loadcell) 21, the fuel pressure sensor 22, a fuel temperature sensor 23 and a molded IC 24. The stem 21 is provided to the body 11. The stem 21 has a diaphragm 21a which elastically deforms in response to high fuel pressure in the high-pressure passage 11a. The fuel pressure sensor 22 is disposed on a diaphragm 21a to transmit a pressure detection signal depending on an elastic deformation of the diaphragm 21a toward the ECU 30.

The fuel temperature sensor 23 is disposed on the diaphragm 21a. The fuel temperature detected by the temperature sensor 23 can be assumed as the temperature of the high pressure fuel in the high-pressure passage 11a. That is, a sensor unit 20 has functions of a fuel temperature sensor and a fuel pressure sensor.

The molded IC 24 includes a nonvolatile memory 24a (memory portion), an amplifier circuit which amplifies a pressure detection signal transmitted from the sensors 22, 23 and a transmitting circuit which transmits the detection signals to the ECU 30.

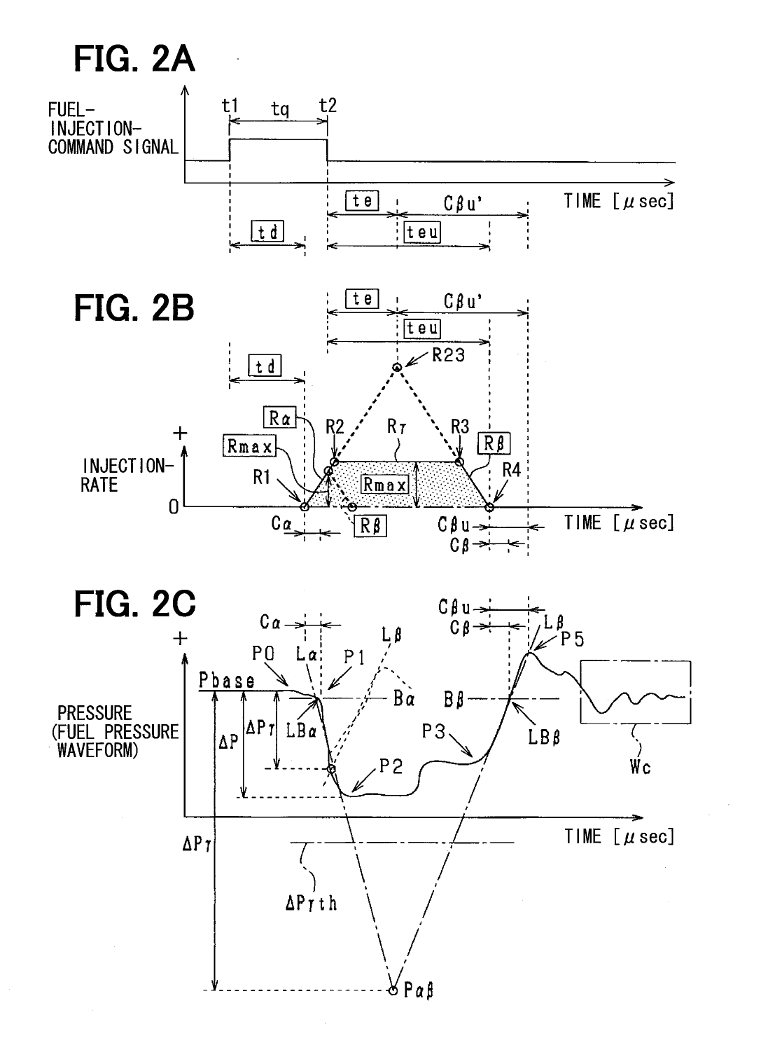

The ECU 30 has a microcomputer which computes a target fuel injection condition, such as the number of fuel injections, a fuel-injection-start time, a fuel-injection-end time, and a fuel injection quantity. For example, the microcomputer stores an optimum fuel-injection condition with respect to the engine load and the engine speed in a fuel-injection condition map. Then, based on the current engine load and the engine speed, the target fuel-injection condition is computed in view of the fuel-injection condition map. Then, the fuel-injection-command signals “t1”, “t2”, “Tq” corresponding to the computed target fuel-injection condition (refer to FIG. 2A) is established based on injection-rate parameters “td”, “te”, “Rα”, “Rβ”, “Rmax”, a bending-start time “tx”, and an inclination “Δtb”, which will be described later.

Referring to FIGS. 2A to 7, a processing of fuel injection control will be described hereinafter.

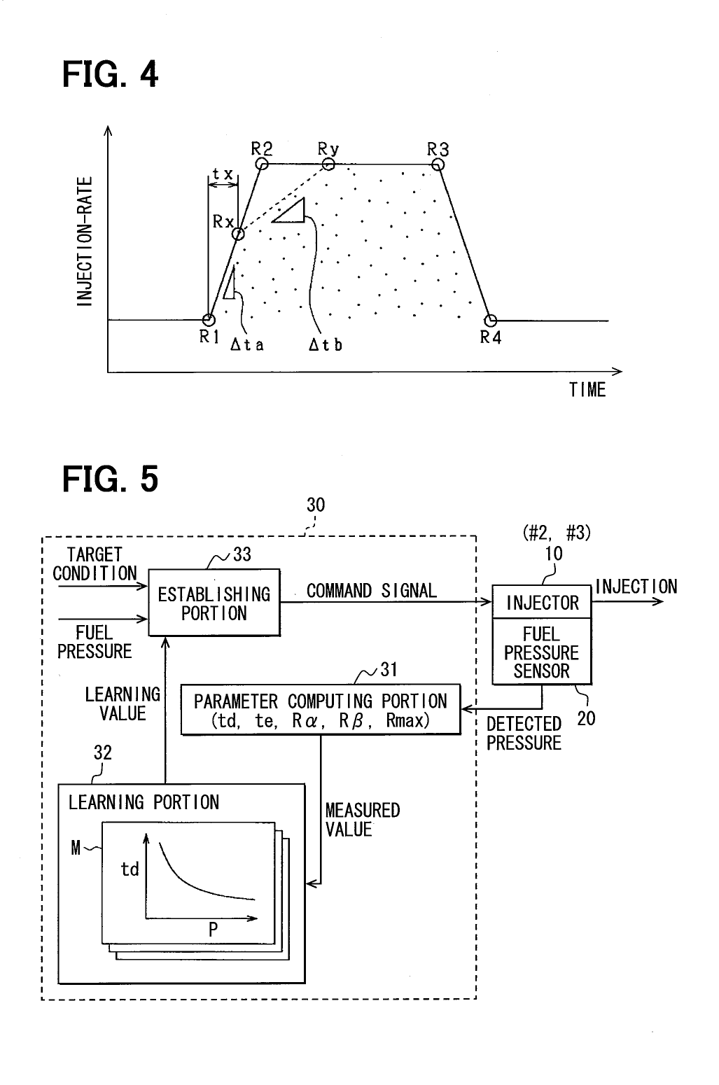

For example, in a case that #2 fuel injector 10 mounted to #2 cylinder injects the fuel, a variation in fuel pressure due to a fuel injection is detected as a fuel pressure waveform (refer to a solid line FIG. 2C) based on detection values of the fuel pressure sensor 22 provided to #2 fuel injector 10. Based on the detected fuel pressure waveform, a fuel injection-rate waveform (refer to FIGS. 2B and 4) representing a variation in fuel injection quantity per a unit time is computed. Then, the injection-rate parameters Rα, Rβ and Rmax which identify the injection-rate waveform are learned, and the injection-rate parameters “te” and “td” which identify the correlation between the injection-command signals (pulse-on time point t1, pulse-off time point t2 and pulse-on period Tq) and the injection condition are learned.

Specifically, a descending pressure waveform from a point P1 to a point P2 is approximated to a descending straight line Lα by least square method. At the point P1, the fuel pressure starts to descend due to a fuel injection. At the point P2, the fuel pressure stops to descend. Then, a time point LBα at which the fuel pressure becomes a reference value Bα on the approximated descending straight line Lα is computed. Since the time point LBα and the fuel-injection-start time (injection-rate-ascend start time) R1 have a high correlation with each other, the fuel-injection-start time (injection-rate-ascend start time) R1 is computed based on the time point LBα. Specifically, a time point prior to the time point LBα by a specified time delay Ca is defined as the fuel-injection-start time (injection-rate-ascend start time) R1. That is, based on the descending waveform in the fuel pressure waveform, the fuel-injection-start time (injection-rate-ascend start time) R1 is computed.

Further, an ascending pressure waveform from a point P3 to a point P5 is approximated to an ascending straight line L6 by least square method. At the point P3, the fuel pressure starts to ascend due to a termination of a fuel injection. At the point P5, the fuel pressure stops to ascend. Then, a time point LBβ at which the fuel pressure becomes a reference value Bβ on the approximated ascending straight line Lβ is computed. Since the time point LBβ and the fuel-injection-end time (injection-rate-descend end time) R4 have a correlation with each other, the fuel-injection-end time (injection-rate-descend end time) R4 is computed based on the time point LBβ. Specifically, a time point prior to the time point LBβ by a specified time delay Cβ is defined as the fuel-injection-end time (injection-rate-descend end time) R4. That is, based on the ascending waveform in the fuel pressure waveform, the fuel-injection-end time (injection-rate-descend end time) R4 is computed.

In view of a fact that an inclination of the descending straight line Lα and an inclination of the injection-rate increase have a high correlation with each other, an inclination of a straight line Rα, which represents an increase in fuel injection-rate in FIG. 2B, is computed based on an inclination of the descending straight line Lα. Specifically, an inclination of the straight line Lα is multiplied by a specified coefficient to obtain the inclination of the straight line Rα. Similarly, in view of a fact that an inclination of the ascending straight line Lβ and an inclination of the injection-rate decrease have a high correlation with each other, an inclination of a straight line Rβ, which represents a decrease in fuel injection-rate, is computed based on an inclination of the ascending straight line Lβ.

Then, based on the straight lines Rα and Rβ, a valve-close start time R23 is computed. At this time R23, the valve body 12 starts to be lifted down along with a fuel-injection-end command signal. Specifically, an intersection of the straight lines Rα and Rβ is defined as the valve-close start time R23. Further, a fuel-injection-start time delay “td” of the fuel-injection-start time (injection-rate-ascend start time) R1 relative to the pulse-on time point t1 is computed. Also, a time delay “te” of the valve-close start time R23 relative to the pulse-off time point t2 is computed.

An intersection of the descending straight line Lα and the ascending straight line Lβ is obtained and a pressure corresponding to this intersection is computed as an intersection pressure Pαβ. Further, a differential pressure ΔPγ between a reference pressure “Pbase” and the intersection pressure Pap is computed. In view of the fact that the differential pressure ΔPγ and the maximum injection-rate Rmax have a high correlation with each other, the maximum injection-rate Rmax is computed based on the differential pressure ΔPγ. Specifically, the differential pressure ΔPγ is multiplied by a correlation coefficient Cγ to compute the maximum injection-rate Rmax. However, in a case that the differential pressure ΔPγ is less than a specified value ΔPγth (small injection), the maximum fuel injection-rate Rmax is defined as follows:

Rmax=ΔPγ×Cγ

In a case that the differential pressure ΔPγ is not less than the specified value ΔPγth (large injection), a predetermined value Rγ is defined as the maximum injection-rate Rmax.

The small injection corresponds to a case in which the valve 12 starts to be lifted down before the injection-rate reaches the predetermined value Rγ. The fuel injection quantity is restricted by the seat surface 12a. Meanwhile, the large-injection corresponds to a case in which the valve 12 starts to be lifted down after the injection-rate reaches the predetermined value Rγ. The fuel injection quantity depends on the flow area of the injection port 11b. That is, when the injection command period Tq is long enough and the injection port has been opened even after the injection-rate reaches the maximal injection-rate, the shape of the injection rate waveform becomes pentagon as shown by a dashed line in FIG. 4. Meanwhile, in a case of the small-injection, the shape of the injection-rate waveform becomes triangle, as shown by a dashed line in FIG. 2B.

The above predetermined value Rγ, which corresponds to the maximum injection-rate Rmax in case of the large-injection, varies along with an aging deterioration of the fuel injector 10. For example, if particulate matters are accumulated in the injection port 11b and the fuel injection quantity decreases along with age, the pressure drop amount ΔP shown in FIG. 2C becomes smaller. Also, if the seat surface 12a is worn away and the fuel injection quantity is increased, the pressure drop amount ΔP becomes larger. It should be noted that the pressure drop amount ΔP corresponds to a detected pressure drop amount which is caused due to a fuel injection. For example, it corresponds to a pressure drop amount from the reference pressure “Pbase” to the point P2, or from the point P1 to the point P2.

In the present embodiment, in view of the fact that the maximum injection-rate Rmax (predetermined value Rγ) in a large-injection has high correlation with the pressure drop amount ΔP, the predetermined value Rγ is established based on the pressure drop amount ΔP. That is, the learning value of the maximum injection-rate Rmax in the large-injection corresponds to a learning value of the predetermined value Rγ based on the pressure drop amount ΔP.

As above, the injection-rate parameters “td”, “te”, “Rα”, “Rβ” and “Rmax” can be derived from the fuel pressure waveform. Moreover, the trapezoidal injection-rate waveform shown by a solid line in FIGS. 2B and 4 can be computed. This trapezoidal injection-rate waveform is corrected into a pentagonal injection-rate waveform, as follows.

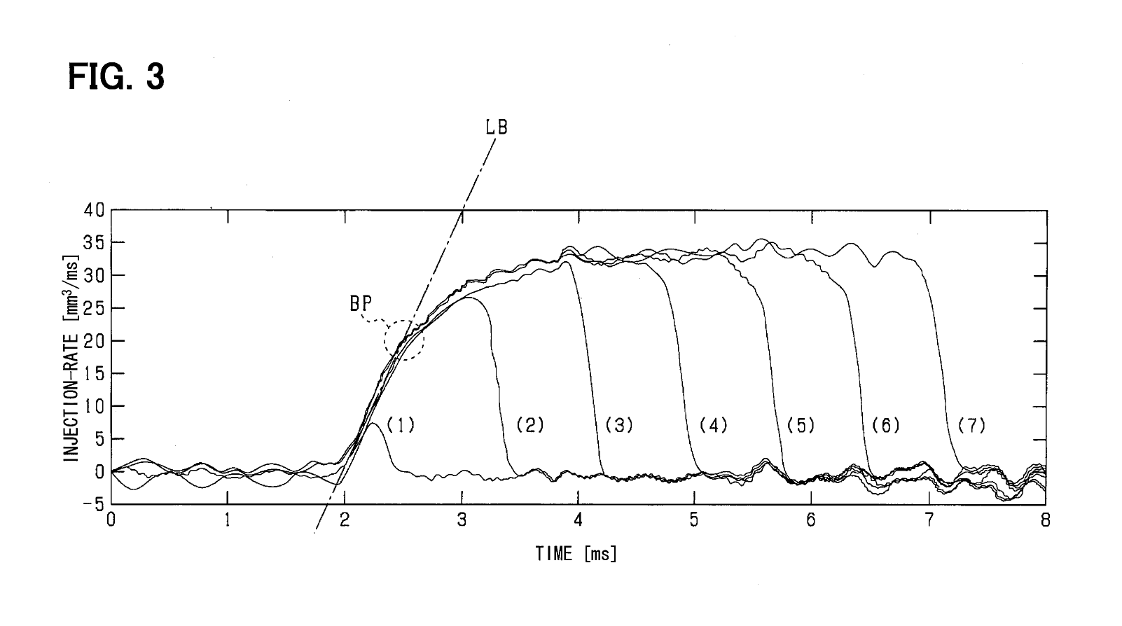

FIG. 3 is a graph showing experiment results of actual injection-rate waveform, which is actually measured by a testing device. Reference numerals (1) to (7) are measuring results of cases in which the fuel injection quantity is 2 mm³, 25 mm³, 50 mm³, 75 mm³, 100 mm³, 125 mm³, and 150 mm³, respectively.

According to this measuring result shown in FIG. 3, an injection-rate ascend speed becomes slower from a vicinity of a point denoted by “BP”. That is, as schematically shown in FIG. 4, the injection-rate ascend speed becomes slower from a bending point “Rx” before the injection rate reaches the injection-rate-ascend end point R2. The measured injection-rate waveform is close to pentagon connecting R1, Rx, Ry, R3, and R4 rather than trapezoid connecting R1, R2, R3 and R4.

In view of the above, the trapezoidal injection-rate waveform is corrected to a pentagonal injection-rate waveform. This pentagonal injection-rate waveform is an injection-rate waveform corresponding to the injection command signals (refer to FIG. 2A). An area of the computed pentagonal injection-rate waveform (shaded area in FIG. 4) corresponds to a fuel injection quantity. Thus, the fuel injection quantity can be computed based on this area.

FIG. 5 is a block diagram showing a learning process of an injection-rate parameter and a setting process of an injection command signal transmitted to the fuel injector 10. Specifically, FIG. 5 shows a configuration and functions of the ECU 30. An injection-rate-parameter computing portion 31 computes the injection-rate parameters “td”, “te”, “Rα”, “Rβ” and “Rmax” based on the fuel pressure waveform detected by the fuel pressure sensor 22.

A learning portion 32 learns the computed injection-rate parameters and stores the updated parameters in a memory of the ECU 30. The trapezoidal injection-rate waveform derived from the computed injection-rate parameters is corrected into a pentagonal injection-rate waveform. The area of the pentagonal injection-rate waveform is computed to obtain the fuel injection quantity. The obtained fuel injection quantity is stored in the memory of the ECU 30.

Since the injection-rate parameters and the fuel injection quantity vary according to the supplied fuel pressure (fuel pressure in the common rail 42), it is preferable that the injection-rate parameters and the fuel injection quantity are learned in association with the supplied fuel pressure or a reference pressure “Pbase” (refer to FIG. 2C). The fuel injection-rate parameters relative to the fuel pressure are stored in an injection-rate parameter map M shown in FIG. 5.

An establishing portion 33 obtains the injection-rate parameter and the fuel injection quantity corresponding to the current fuel pressure from the injection-rate parameter map M. Then, based on the obtained injection-rate parameters and fuel injection quantity, the injection-command signals “t1”, “t2”, “Tq” corresponding to the target injection condition are established. When the fuel injector 10 is operated according to the above injection-command signals, the fuel pressure sensor 22 detects the fuel pressure waveform. Based on this fuel pressure waveform, the injection-rate-parameter computing portion 31 computes the injection-rate parameters “td”, “te”, “Rα”, “Rβ” and “Rmax” and the fuel injection quantity.

That is, the actual fuel injection condition (injection-rate parameters “td”, “te”, “Rα”, “Rβ”, “Rmax” and fuel injection quantity) relative to the fuel-injection-command signals is detected and learned. Based on this learning value, the fuel-injection-command signals corresponding to the target injection condition are established. Therefore, the fuel-injection-command signals are feedback controlled based on the actual injection condition, whereby the actual injection condition is accurately controlled in such a manner as to agree with the target injection condition even if the deterioration with age is advanced. Especially, the injection command period “Tq” is feedback controlled so that the actual fuel injection quantity agrees with the target fuel injection quantity. In the following description, a cylinder in which a fuel injection is currently performed is referred to as an injection cylinder and a cylinder in which no fuel injection is currently performed is referred to as a non-injection cylinder. Further, a fuel pressure sensor 22 provided to the injection cylinder 10 is referred to as an injection-cylinder pressure sensor and a fuel pressure sensor 22 provided to the non-injection cylinder 10 is referred to as a non-injection-cylinder pressure sensor.

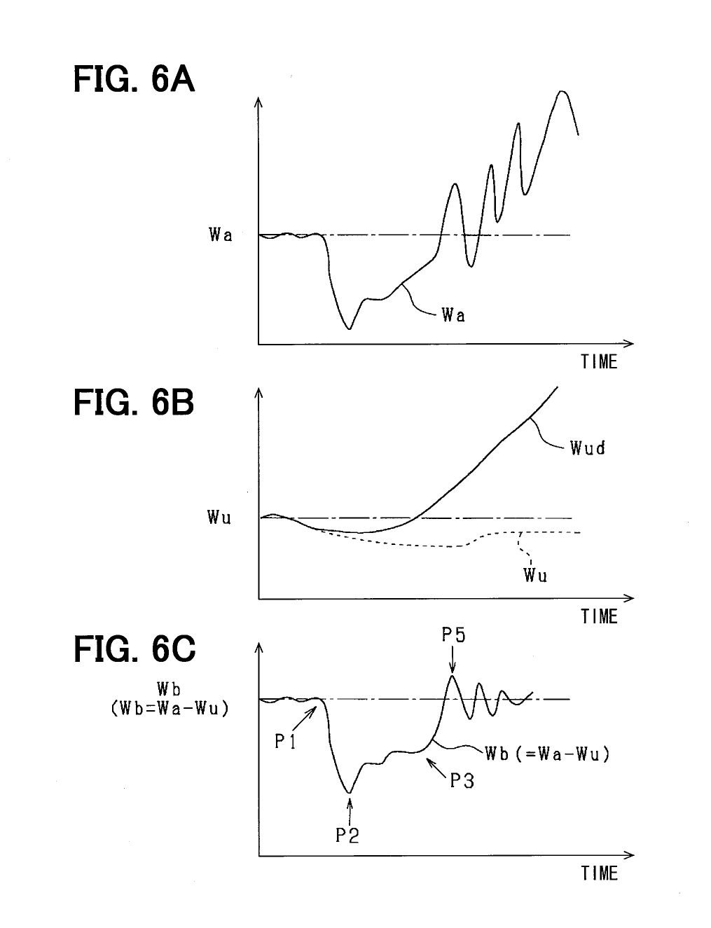

The fuel pressure waveform Wa (refer to FIG. 6A) detected by the injection-cylinder pressure sensor 22 includes not only the waveform due to a fuel injection but also the waveform due to other matters described below. In a case that the fuel pump 41 intermittently supplies the fuel to the common-rail 42, the entire fuel pressure waveform Wa ascends when the fuel pump supplies the fuel while the fuel injector 10 injects the fuel. That is, the fuel pressure waveform Wa includes a fuel pressure waveform Wb (refer to FIG. 6C) representing a fuel pressure variation due to a fuel injection and a pressure waveform Wud (refer to FIG. 6B) representing a fuel pressure increase by the fuel pump 41.

Even in a case that the fuel pump 41 supplies no fuel while the fuel injector 10 injects the fuel, the fuel pressure in the fuel injection system decreases immediately after the fuel injector 10 injects the fuel. Thus, the entire fuel pressure waveform Wa descends. That is, the fuel pressure waveform Wa includes a waveform Wb representing a fuel pressure variation due to a fuel injection and a waveform Wu (refer to FIG. 6B) representing a fuel pressure decrease in the fuel injection system.

Since the pressure waveform Wud (Wu) detected by the non-injection-cylinder pressure sensor 22 provided in the non-injection cylinder represents the fuel pressure in the common-rail 42, the non-injection pressure waveform Wud (Wu) is subtracted from the injection pressure waveform Wa detected by the injection-cylinder pressure sensor 22 to obtain the injection waveform Wb. The fuel pressure waveform shown in FIG. 2C is the injection waveform Wb.

Moreover, in a case that a multiple injection is performed, a pressure pulsation Wc due to a prior injection, which is shown in FIG. 2C, overlaps with the fuel pressure waveform Wa. Especially, in a case that an interval between injections is short, the fuel pressure waveform Wa is significantly influenced by the pressure pulsation Wc. Thus, it is preferable that the pressure pulsation Wc and the non-injection pressure waveform Wu (Wud) are subtracted from the fuel pressure waveform Wa to compute the injection waveform Wb.

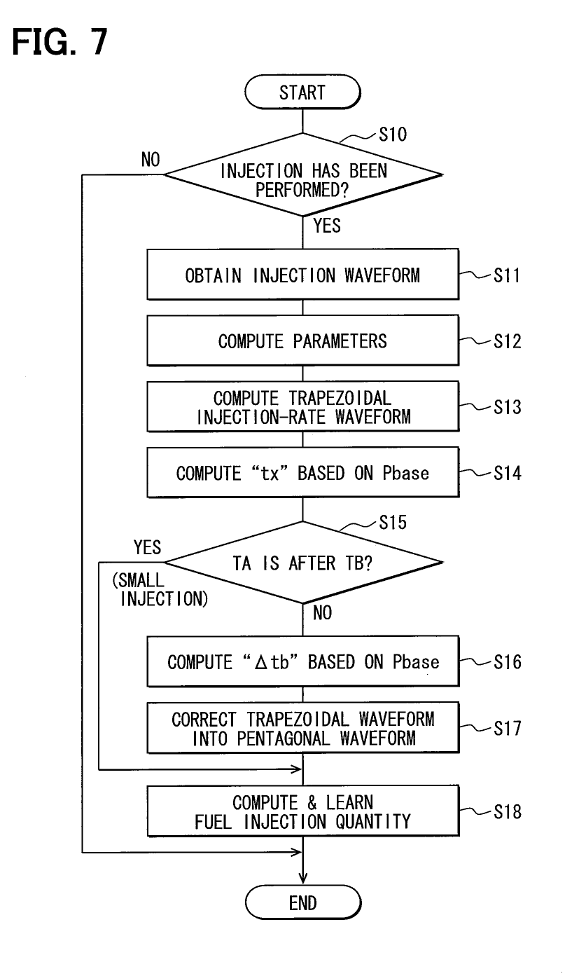

Referring to FIG. 7, a processing for correcting a trapezoidal injection-rate waveform into a pentagonal injection-rate waveform will be described. This processing shown in FIG. 7 is executed at a specified interval by a microcomputer of the ECU 30.

In step S10, the computer determines whether a fuel injection has been performed by the fuel injector 10. When the answer is YES, the procedure proceeds to step S11 in which the pressure pulsation Wc and the non-injection pressure waveform Wu (Wud) are subtracted from the fuel pressure waveform Wa to obtain the injection waveform Wb. This process corresponds to a fuel pressure waveform detecting portion. In step S12, the injection-rate-parameter computing portion 31 computes the injection-rate parameters “td”, “te”, “Rα”, “Rβ” and “Rmax” based on the fuel pressure waveform obtained in step S11. In step S13, based on the injection-rate parameters, the trapezoidal injection-rate waveform is computed.

In the following description, a part of the injection-rate waveform where the injection-rate is ascending is referred to as an ascending-waveform portion. In the ascending-waveform portion, a point where the injection-rate ascending speed becomes slower is referred to as a bending point “Rx”. A time period from when the injection-rate-ascending starts until when the bending point “Rx” appears is referred to as a bending start time period “tx”. Further, in the ascending-waveform portion, an inclination of before the bending point “Rx” appears is referred to as an anterior-inclination “Δta” and an inclination of after the bending portion “Rx” appears is referred to as a posterior-inclination “Δtb”.

Before the fuel injector 10 is mounted in the internal combustion engine, the bending start time period “tx” and the posterior-inclination “Δtb”, which are obtained from the experimental results shown in FIG. 3, are previously stored in a memory 24a (memory portion) provided in the fuel injector 10. Besides, if the reference pressure “Pbase” is varied, the bending start time period “tx” and the posterior-inclination “Δtb” are also varied. According to the present embodiment, the bending start time period “tx” and the posterior-inclination “Δtb” corresponding to the reference pressure “Pbase” are previously obtained by experiments. The obtained “tx” and “Δtb” are stored in the memory 24a in association with the reference pressure “Pbase”.

In step S14, the computer computes the reference pressure “Pbase” from the fuel pressure waveform obtained in step S11. And then the bending start time period “tx” corresponding to the reference pressure “Pbase” is obtained. In step S15, the computer determines whether a time point “TA” at which the time period “tx” has elapsed is after a time point “TB” at which the injection-rate becomes the maximum injection-rate Rmax.

In a case of the small injection, since the injection-rate waveform is triangle, the bending point “Rx” does not appear. Thus, if the time point “TA” is after the time point “TB”, the fuel injection is the small injection in which the injection-rate falls before the bending point “Rx” appears. That is, when the answer is YES in step S15, the procedure proceeds to step S18.

Meanwhile, when the answer in NO in step S15, that is, when it is determined that the time point “TA” is not after the time point “TB”, the procedure proceeds to step S16 in which the posterior-inclination “Δtb” corresponding to the reference pressure “Pbase” is obtained. In step S17 (injection-rate waveform computing portion), the trapezoidal injection-rate waveform computed in step S13 is corrected into the pentagonal injection-rate waveform by means of the time period “tx” and the posterior-inclination “Δtb” computed in steps S14 and S16. That is, the trapezoid illustrated by a solid line in FIG. 4 is corrected into pentagon illustrated by a dashed line in FIG. 4.

In step S18, an area of the corrected pentagonal injection-rate waveform (shaded area in FIG. 4) or an area of the triangle injection-rate waveform in the small injection is computed as the fuel injection quantity. Then the computed fuel injection quantity is learned by the learning portion 32 in association with the reference pressure “Pbase”. The establishing portion 33 establishes the injection command period “Tq” based on the fuel injection quantity learned in step S18.

As described above, according to the present embodiment, the trapezoidal injection-rate waveform is corrected into the pentagonal injection-rate waveform having the bending point “Rx”. Therefore, since the injection-rate waveform can be brought into an actual injection-rate waveform, the fuel injection quantity can be computed (estimated) with high accuracy.

Moreover, since the time period “tx” and the posterior-inclination “Δtb” are stored in the memory 24a in association with the reference pressure “Pbase”, the pentagonal injection-rate waveform can be accurately computed.

### Second Embodiment

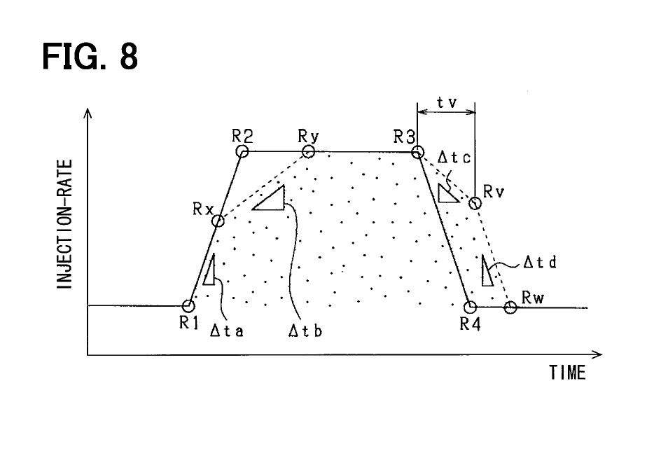

According to a second embodiment, the trapezoidal injection-rate waveform is corrected into a hexagonal injection-rate waveform. When the needle valve 12 is lifted down to decrease the injection-rate, the injection-rate descending speed varies at a second bending point “Rv” shown in FIG. 8.

In the following description, a part of the injection-rate waveform where the injection-rate is descending is referred to as a descending-waveform portion (R3 to Rw in FIG. 8). In the descending-waveform portion, a point where the injection-rate descending speed becomes faster is referred to as a second bending point “Rv”. A time period from when the injection-rate descending starts until when the second bending point “Rv” appears is referred to as a second bending start time period “tv”. Further, in the descending-waveform portion, an inclination of before the second bending point “Rv” appears is referred to as a second anterior-inclination “Δtc” and an inclination of after the bending portion “Rv” appears is referred to as a second posterior-inclination “Δtd”.

The injection-rate waveform is corrected in such a manner that the second anterior-inclination “Δtc” becomes smaller than the second posterior-inclination “Δtd”.

The second bending start time period “tv” and the second anterior-inclination “Δtc” are previously stored in the memory 24a in association with the reference pressure “Pbase”. The trapezoid illustrated by a solid line in FIG. 8 is corrected into hexagon illustrated by a dashed line in FIG. 8. The area of the hexagonal injection-rate waveform is computed as the fuel injection quantity.

As described above, according to the second embodiment, the trapezoidal injection-rate waveform is corrected into the hexagonal injection-rate waveform having the second bending point “Rv”. Therefore, since the injection-rate waveform can be brought into an actual injection-rate waveform, the fuel injection quantity can be computed (estimated) with high accuracy.

Moreover, since the second time period “tv” and the second anterior-inclination “Δtc” are stored in the memory 24a in association with the reference pressure “Pbase”, the hexagonal injection-rate waveform can be accurately computed.

### Other Embodiment

The present invention is not limited to the embodiments described above, but may be performed, for example, in the following manner. Further, the characteristic configuration of each embodiment can be combined.

Depending on the fuel temperature at time of fuel injection, the time period “tx”, the posterior-inclination “Δtb”, the second time period “tv” and the second anterior-inclination “Δtc” are varied. Thus, “tx”, “Δtb”, “tv” and “Δtc” may be previously obtained by experiments and stored in the memory 24a in association with the fuel temperature. Besides, the fuel temperature can be obtained by the fuel temperature sensor 23.

In the above embodiments, the injection-rate waveform is corrected into pentagon or hexagon connecting each point by straight line. However, the injection-rate waveform may be corrected into a shape which is defined by connecting each point by curved lines.

In the second embodiment, the injection-rate waveform is corrected into hexagon having two bending points “Rx” and “Rv”. However, by deleting the bending point “Rx”, the injection-rate waveform may be corrected into pentagon connecting the five points “R1”, “R2”, “R3”, “Rv” and “Rw”.

The fuel pressure sensor 22 can be arranged at any place in a fuel supply passage between an outlet 42a of the common-rail 42 and the injection port 11b. For example, the fuel pressure sensor 20 can be arranged in a high-pressure pipe 42b connecting the common-rail 42 and the fuel injector 10. The high-pressure pipe 42b and the high-pressure passage 11a in the body 11 correspond to a fuel supply passage of the present invention.

What is claimed is:

1. A fuel-injection-condition estimating apparatus for a fuel injection system having a fuel injector injecting a fuel accumulated in an accumulator and a fuel pressure sensor detecting a fuel pressure in a fuel supply passage from the accumulator to an injection port of the fuel injector, the fuel-injection-condition estimating apparatus comprising:
a fuel-pressure-waveform detecting portion which detects a variation in the fuel pressure as a fuel pressure waveform based on a detection value of the fuel pressure sensor; and
an injection-rate waveform computing portion which computes an injection-rate waveform indicative of a variation in an injection-rate based on the fuel pressure waveform, wherein:
the injection-rate waveform computing portion computes an ascending-waveform portion where the injection-rate is ascending due to a fuel injection in such a manner that an injection-rate ascending speed becomes slower at a specified point on the ascending-waveform portion.

2. A fuel-injection-condition estimating apparatus according to claim 1, wherein:
the specified point at which the injection-rate ascending speed becomes slower is referred to as a bending point;
a time period from when the injection-rate-ascending starts until when the bending point appears is referred to as a bending start time period;
the fuel-injection-condition estimating apparatus further comprising a memory portion which previously stores the bending start time period obtained by an experiment; and
the injection-rate waveform computing portion computes the ascending-waveform portion based on the bending start time period stored in the memory portion.

3. A fuel-injection-condition estimating apparatus according to claim 2, wherein:
the memory portion stores the bending start time period corresponding to a reference pressure which is a fuel pressure supplied to the fuel injector;
the injection-rate waveform computing portion obtains the bending start time period of a time when the fuel pressure waveform is detected; and
the injection-rate waveform computing portion computes the ascending-waveform portion based on the obtained bending start time period.

4. A fuel-injection-condition estimating apparatus according to claim 1, wherein:
an inclination of the ascending-waveform portion of after the bending portion appears is referred to as a posterior-inclination;
the fuel-injection-condition estimating apparatus further comprising a memory portion which previously stores the posterior-inclination obtained by an experiment, wherein
the injection-rate waveform computing portion computes the ascending-waveform portion based on the posterior-inclination stored in the memory portion.

5. A fuel-injection-condition estimating apparatus according to claim 4, wherein
the memory portion stores the posterior-inclination corresponding to a reference pressure which is a fuel pressure supplied to the fuel injector;
the injection-rate waveform computing portion obtains the posterior-inclination of a time when the fuel pressure waveform is detected; and
the injection-rate waveform computing portion computes the ascending-waveform portion based on the obtained posterior-inclination.

6. A fuel-injection-condition estimating apparatus according to claim 1, wherein:
the specified point at which the injection-rate ascending speed becomes slower is referred to as a bending point; and
the injection-rate waveform computing portion computes the injection-rate waveform based on a pentagonal model defined by connecting five points of an injection-rate-ascend start time, the bending portion, an injection-rate-ascend end time, an injection-rate-descend start time and an injection-rate-descend end time.
